(19) United States
(12) Patent Application Publication
(10) Pub. No.: US 2023/0143587 A1
(43) Pub. Date: May 11, 2023

(54) DESALINATION AND LITHIUM COLLECTION SYSTEM

(71) Applicant: Cole Franklin, San Clemente, CA (US)

(72) Inventor: Cole Franklin, San Clemente, CA (US)

(21) Appl. No.: 18/050,454

(22) Filed: Oct. 27, 2022

Related U.S. Application Data
(60) Provisional application No. 63/276,477, filed on Nov. 5, 2021.

(51) Int. Cl. C25C 1/02; C25C 7/02; C25C 7/06

(52) U.S. Cl. CPC C25C 1/02; C25C 7/02; C25C 7/06

(57) ABSTRACT

A desalination and lithium collection system has a primary brine chamber receiving brine from a brine inlet. A charged metal has anodes and cathodes, submerged in the brine in the primary brine chamber. Electrical power applied is to the charged metal as alternating current having a frequency of less than 2kHz for conducting a primary electrolysis. A water vapor collection chamber fluidly connected to the primary brine chamber and configured to collect water vapor generated from the charged metal. A condenser chamber is fluidly connected to the water vapor collection chamber and configured to condense water vapor. A freshwater chamber is fluidly connected to the condenser and configured to collect freshwater.

The present invention claims priority from U.S. provisional patent 63/276,477 filed Nov. 5, 2021 entitled Novel Method To Desalinize Through Fast Oxidation Of Noble Metals, by same inventor Cole Franklin, the disclosure of which is incorporated herein by reference.

### FIELD OF THE INVENTION

The present invention is in the field of desalination and lithium extraction.

### DISCUSSION OF RELATED ART

California seeks an end to new gasoline car sales over the next decade, which will increase demand for lithium for use in lithium electric vehicle batteries. Highly concentrated brine having high concentration of lithium is already known in areas such as the Salton Sea in California. The industry needs an environmentally friendly method to extract lithium deposits from areas with highly concentrated brine.

Modern desalination plants utilize filtration and reverse osmosis to remove salt ions from the seawater to create freshwater. The downside to the modern technique is it forms brine, a higher concentration of salty water is then dumped back into the ocean creating problems for sea life. Current saltwater power plants rely on reverse osmosis to create pressure between a salty water and fresh water. These systems can be used in areas where fresh water and salt water is available. So far there are no solutions to create saltwater power in areas where fresh water does not exist. Inventor Wilkins describes a Method And Apparatus For Desalination in U.S. Pat. No. 8,182,693, filed Dec. 16, 2009 by Siemens Industry Inc., which involves filtering, then applying an electro deionized station process, the disclosure of which is incorporated herein by reference. A variety of different ultrasonic methods having frequency ranges of 20 kHz and over have been used for brine desalination.

### SUMMARY OF THE INVENTION

The present invention is a combination desalination and lithium recovery method. It is an object of the present invention to conserve natural resources by producing clean water and lithium. Lithium is a key mineral needed for electrically powered vehicles and photovoltaic powered homes.

A desalination and lithium collection system has a primary brine chamber receiving brine from a brine inlet. A charged metal has anodes and cathodes, submerged in the brine in the primary brine chamber. Electrical power applied is to the charged metal as alternating current having a frequency of less than 2 kHz for conducting a primary electrolysis. A water vapor collection chamber fluidly connected to the primary brine chamber and configured to collect water vapor generated from the charged metal. A condenser chamber is fluidly connected to the water vapor collection chamber and configured to condense water vapor. A freshwater chamber is fluidly connected to the condenser and configured to collect freshwater.

The desalination and lithium collection system also has a secondary brine chamber. The secondary brine chamber houses a secondary electrolysis that includes a lithium filter and a charged lithium collection plate that is preferably made of copper. The lithium precipitates from the brine, passes through the lithium filter and adheres to the charged lithium collection plate during the secondary electrolysis. The copper plate can then be replaced with a new one and shipped to a lithium battery manufacturing facility. The lithium battery manufacturing facility can then reverse the electrolysis to transfer the lithium onto battery components. The lithium battery manufacturing facility can then send the clean lithium collection plates back to the desalination and lithium collection facility for continuous and sustainable recycling.

The charged metal is preferably a noble charged metal selected from the group of copper, silver, gold, platinum, or the like. The water vapor collection chamber is connected to a primary turbine. The primary turbine generates electricity that is applied back to the electrical power for regenerating a portion of the electrical power used to charge the charged metal. The charged metal oxidizes the brine with a reduction wherein water disassociates at an anode of the charged metal during the primary electrolysis. The water changes phase from a liquid to a gas.

### BRIEF DESCRIPTION OF THE DRAWINGS

FIG. 1 is a diagram showing the desalination and lithium recovery system and method.

FIG. 2 is a diagram showing turbine energy recovery.

FIG. 3 is a diagram showing a metal rod array having anodes and cathodes.

The following callout list of elements can be a useful guide in referencing the element numbers of the drawings.

20 Primary Brine Chamber

21 Brine Inlet

23 Excited Noble Metal

24 Oxidizing Reaction

25 Bubbles

26 Brine

30 Vapor Tank

31 Water Vapor

32 Condenser

33 Freshwater

34 First Turbine

35 Electricity Transmission

36 Potable Overpressure

37 Water Power Source

38 Freshwater Outlet

40 Secondary Brine Chamber

41 Filter

42 Cover Plate

43 Lithium Deposit

51 First Metal Member

52 Second Metal Member

53 Third Metal Member

54 Fourth Metal Member

55 Fifth Metal Member

56 Sixth Metal Member

### DETAILED DESCRIPTION OF THE PREFERRED EMBODIMENT

As seen in FIG. 1, a column of water vapor 31 rises in a vapor tank 30 and provides condensing water in a condenser 32. The freshwater 33 is received from the condensing water area. An excited noble metal 23 in a primary brine chamber 20 receives ocean water and brine 26 from a brine inlet 21. After conversion to gas, the brine 26 becomes more concentrated and is led to a brine outlet 22. The brine outlet 22 connects to a secondary brine chamber 40. The secondary brine chamber 40 has a filter 41 with a copper plate 42 behind the filter 41. Lithium deposits 43 are received on the copper plate 41 while other materials do not pass through the filter 41.

Thus, the present invention uses a first electrolysis in a primary brine chamber 20 for vaporizing water, to concentrate brine, and then has a secondary brine chamber 40 which can then be used to extract with him deposits from water through a filter 41. The lithium ions are electromagnetically drawn through the filter 41 to the cover plate 42 because the copper plate has an electrical charge.

The present invention method powers up the noble metal and drives high energy oxidization through the salts which would normally slowly corrode and oxidize. Here instead depending on frequency, power and other modes of excitation can cause the sea water to quickly transition to steam. Leaving salts and other minerals behind while steam is captured and condensed into potable water.

The present invention method uses use low power to excite noble metals such as Ag, W, Ti, Pd, Pt, and others to drive high energy oxidization through the salts which would normally slowly corrode and oxidize the metal. Here instead depending on frequency (with lower frequency preferred in the range of 0-1000 Hz) and power over 10W creates other modes of excitation that cause the sea water to quickly transition to vapor. Leaving salts and other minerals behind while the vapor is captured and condensed into potable water. These vapors can be excited further to steam through the addition of over energy by increasing the power of supplemental energy such as microwave. Once the hot steam is generated the process of water separation becomes one that drives turbines and recovers some of the power used. For example, incoming seawater to a tank can oxidize at and excited noble metal to create water vapor. The water vapor can then be condensed in a cooling tower and collected in a freshwater tank.

This system creates power first from steam generation then produces fresh water that can drive a small power plant to power the steam generation. The excess power can be used to power a grid and provide fresh portable water.

The charged noble metal generates steam which can power a turbine. The turbine generates power and the water remaining from the turbine process can be harvested. The potable overpressure is retained for use. This also generates excess power out which can be transmitted on high-power transmission lines. The turbine or the saltwater power source can then power the charging of the noble metal.

The process preferably is a low-power process. Low power between 0-10W generally has no effect so the operation zone is 11-50W defined by the graph showing the onset of the activation of the material at above 11W, which is preferably in the 25W/cm² area. when higher power is used it would be possible if the load/flow of water is increased then more power if required to keep up. A water flow rate of 50 ml/min at 25W can be defined as operating point, with nonlinear extrapolation at 100 ml/min at 30W and 200 ml/min at 50W and so on.

The power is electrically delivered to the charged noble metal. It is a low frequency process so low frequencies are preferred or even ultra low frequency, but direct current can be used but for ease of operation alternating current in the range of 60-1000 Hz preferably at 60 Hz for compatibility with household electric current. Higher frequencies such as 2 kHz shuts down this process and only heats up the sample. If heating the sample is preferred in a setup Where creating heat is needed in say running a steam turbine then microwave energy is preferred. Microwave energy allows for fast boiling of the solution and once the heated noble metal is obtained can deliver a lot of boiling and steam but this is different than the main noble metal oxidation that dominates the water reduction (i.e. water breaking down into vapor) process. No mechanical energy needs to be delivered to the water.

While power is applied, the brine acts as a catalyst for the water reduction that forms the water vapor and causes the semi noble and noble metal to fast oxidize. Some electrical charge may travel from the anode to the cathode through the brine.

This creates a high-energy oxidization. For example, silver is a noble metal but can oxidize in the presence of applied power and will tarnish and corrode faster than if left in the open air. This process speeds that process up to the point where it releases a photon. This is a similar process being used today in EUV photo lithography where they take a molten W (a semi Noble metal) and shoot water/steam at it and it produces very bright light that is used to expose patterns for semiconductors. The present process is more like a water fountain where this is occurring and the EUV photolithography process is more of a water mist.

The noble metal oxidizes the brine with a simple water reduction where water breaks down at the anode of the metal. The reaction can alternate with oxidation and reduction transposing between the anode and cathode which can alternate with the alternating current.

An example of a half reaction is as follows:

Oxidation at anode: 2 H₂O(l)→O₂(g)+4 H⁺(aq)+4e⁻

Reduction at cathode: 2 H+(aq)+2e-→H₂(g)

the other half is

Cathode (reduction): 2 H₂O(l)+2e⁻→H₂(g)+2 OH⁻(aq)

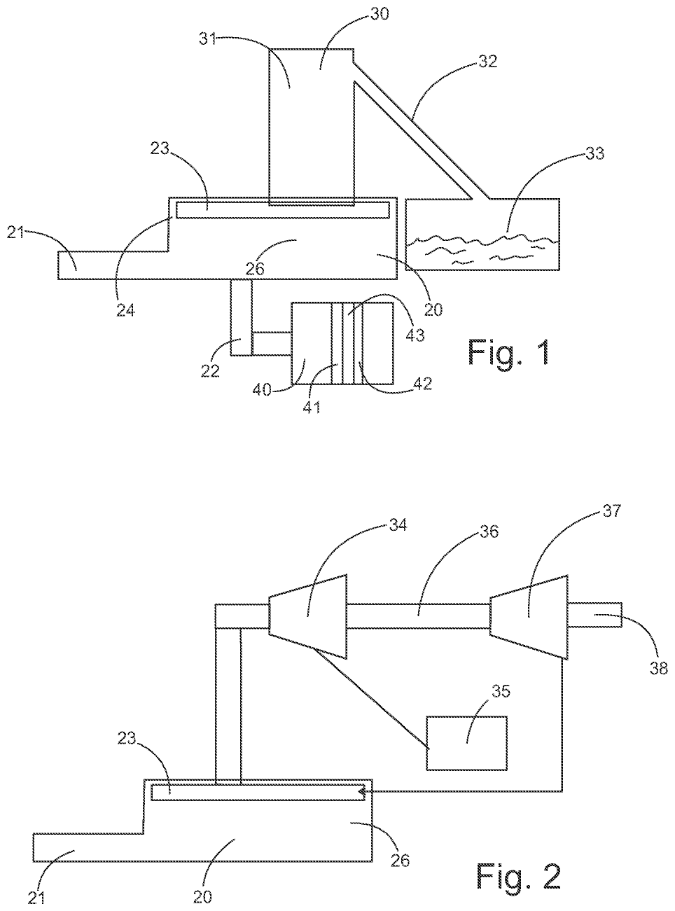

As seen in FIG. 2, the noble charged metal 23 in the brine 26 in the primary brine chamber 20 receives a constant flow of ocean water from a brine inlet 21. The noble charged metal 23 is an array of anodes and cathodes that generate a steam to a first turbine 34 which then draws potable overpressure 36 through a conduit to power a saltwater power source 37. The first turbine 34 powers an electrical transmission 35 for providing electricity to the system. The saltwater power source 37 can provide electrical power back to the noble charged metal 23 so as to recover a portion of electrical energy output. Thus, the turbines decrease the total amount of thermodynamic inefficiency in the system. The anodes and cathodes of the noble charged metal 23 can be powered in a low-frequency process that further conserves electrical resources.

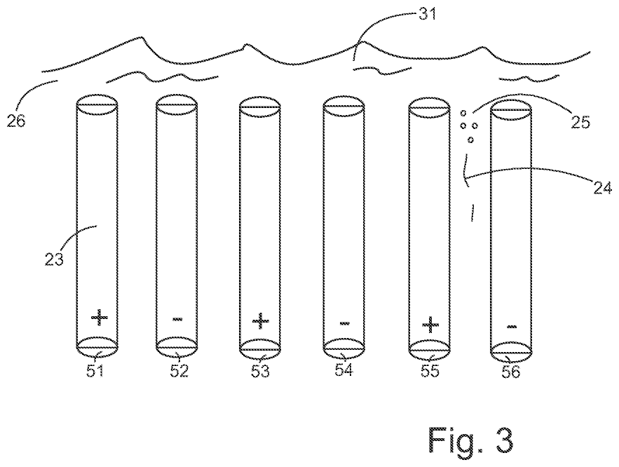

As seen in FIG. 3, the anode and cathode can be formed of conductive materials and applied to a brine solution so that the current passes through the brine. The current may create a plasma that generates steam. The anode and cathode can be formed as rods or bars having water flow passing through them. Preferably, the alternating current under 100hz can be used for creating an oxidizing reaction 24 which manifests as steam in bubbles 25. The brine 26 becomes more concentrated which can then be used for a filter lithium collection such as on a copper plate. The negative bias on the plate provides a secondary electrolysis for lithium collection with a byproduct of desalination.

The key feature of the present invention is that regeneration of electricity by turbines and recovery of freshwater as a byproduct justifies the electrical input expenditure for sequestering lithium via a two-step electrolysis system and method.

1. A desalination and lithium collection system:
a. a primary brine chamber receiving brine from a brine inlet;
b. a charged metal including anodes and cathodes, submerged in the brine in the primary brine chamber;
c. electrical power applied to the charged metal as alternating current having a frequency of less than 2 kHz for conducting a primary electrolysis;
d. a water vapor collection chamber fluidly connected to the primary brine chamber and configured to collect water vapor generated from the charged metal;
e. a condenser chamber fluidly connected to the water vapor collection chamber and configured to condense water vapor; and
f. a freshwater chamber fluidly connected to the condenser and configured to collect freshwater.

2. The desalination and lithium collection system of claim 1, further comprising a secondary brine chamber, wherein the secondary brine chamber houses a secondary electrolysis, wherein the secondary electrolysis includes a lithium filter and a charged lithium collection plate, wherein lithium precipitates from the brine, passes through the lithium filter and adheres to the charged lithium collection plate during the secondary electrolysis.

3. The desalination and lithium collection system of claim 2, wherein the charged metal is a noble charged metal selected from the group of copper, silver, gold, platinum.

4. The desalination and lithium collection system of claim 2, wherein the water vapor collection chamber is connected to a primary turbine, wherein the primary turbine generates electricity that is applied back to the electrical power for regenerating a portion of the electrical power used to charge the charged metal.

5. The desalination and lithium collection system of claim 2, wherein the charged metal oxidizes the brine with a reduction wherein water disassociates at an anode of the charged metal during the primary electrolysis, wherein the water changes phase from a liquid to a gas.

6. The desalination and lithium collection system of claim 1, wherein the charged metal is a noble charged metal selected from the group of copper, silver, gold, platinum.

7. The desalination and lithium collection system of claim 1, wherein the water vapor collection chamber is connected to a primary turbine, wherein the primary turbine generates electricity that is applied back to the electrical power for regenerating a portion of the electrical power used to charge the charged metal.

8. The desalination and lithium collection system of claim 1, wherein the charged metal oxidizes the brine with a reduction wherein water disassociates at an anode of the charged metal during the primary electrolysis, wherein the water changes phase from a liquid to a gas.
